(19) United States
(12) Patent Application Publication
(10) Pub. No.: US 2009/0063356 A1
(43) Pub. Date: Mar. 5, 2009

(54) Consensus Determination Framework

(76) Inventors: Torsten Heise, Wiesloch (DE); Thomas A. Mayer, Leimen (DE); Frank Thome, Karlsruhe (DE)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/849,146

(22) Filed: Aug. 31, 2007

(51) Int. Cl. G06Q 99/00; H04L 9/00

(52) U.S. Cl. 705/80

(57) ABSTRACT

Methods and apparatuses enable determination of consensus between parties to a business transaction. A receiving party of the transaction has a delivery expectation, and a supplying party has a proposed delivery. The delivery expectation and the proposed delivery are represented in transaction data. A consensus determination framework receives the transaction data and dynamically selects one or more consensus parameters to evaluate the transaction data for consensus between the delivery expectation and the proposed delivery. The consensus parameter may be a consensus rule defining a consensus function to perform on the transaction data, and/or a consensus profile indicating acceptable ranges. The consensus framework generates a consensus report to indicate whether consensus is found, and/or what consensus exists, in accordance with the consensus parameter.

### FIELD

Embodiments of the invention relate to inter-party transactions, and more particularly to a framework to determine consensus between the parties.

### BACKGROUND

Inter-party transactions can include the exchange of goods for payment between a supplying party and a receiving party. Such transactions may involve companies with long-standing relationships, such as supplier and customer. While a generally mutual relationship occurs, there may be occasions where there is not perfect agreement on the quantity, timing, or some other aspect of a transaction. The chance for disagreement in certain transactions rises when considering that each company is typically involved in multiple transactions with multiple other parties. The involvement of computer systems in such transactions can help speed up the process of data exchange with respect to transactions, but still requires a great deal of manual effort in negotiating agreement in the transactions. The time and effort spent on negotiating agreement between transacting parties is a cost in time and resources that companies would generally prefer to deploy in other ways.

### SUMMARY

In one embodiment, a consensus determination framework evaluates consensus between parties to a business transaction. A receiving party of the transaction has a delivery expectation, and a supplying party has a proposed delivery. The delivery expectation and the proposed delivery are represented in transaction data received at the consensus determination framework. The framework dynamically selects one or more consensus parameters to evaluate the transaction data for consensus between at least one aspect of the delivery expectation and the proposed delivery. The consensus parameter may be a consensus rule defining a consensus function to perform on the transaction data, and/or a consensus profile indicating acceptable ranges. The consensus framework generates a consensus report to indicate whether consensus is found, and/or what consensus exists, in accordance with the consensus parameter.

In one embodiment, the transaction data is not limited to a specific format. Thus, the consensus framework may identify a format of the transaction data to determine how to apply the consensus parameter to the transactions data. The transaction data may be received from any of a number of sources, including a supply chain management application. The supply chain management application may include business logic that enables the application to invoke the consensus determination without requiring user input to trigger the consensus determination.

In one embodiment, selecting the consensus parameter is performed via a condition technique determination, wherein a key is extracted from the transaction data to search one or more tables to identify a consensus parameter applicable to determine consensus for the transaction data. The consensus may be evaluated for a single aspect of the transaction data at a time. The condition technique can include determining a class to which the consensus parameter belongs.

In one embodiment, a second consensus parameter is selected to evaluate a different consensus for the same aspect of the transaction data, or to evaluate a different consensus for a different aspect of the transaction data. The same consensus parameter may also be used to determine consensus for a different aspect of the transaction data. In one embodiment, multiple consensus determination results can be aggregated to indicate an aggregate consensus in accordance with the application of one or more consensus parameters to one or more aspects of the transaction data.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of an embodiment of a system having a consensus determination engine to determine a consensus of one or more transactions.

FIG. 2A is a block diagram of an embodiment of a system to identify consensus or deviation in transaction data.

FIG. 2B is a block diagram of an embodiment of a system to identify an amount of consensus in transaction data.

FIG. 3 is a block diagram of an embodiment of a consensus determination with a condition technique processor.

FIG. 4 is a flow diagram of an embodiment of a process for determining a consensus in a transaction.

Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

### DETAILED DESCRIPTION

As described herein, a consensus determination framework provides for identifying consensus between parties of a business transaction. In one embodiment, the consensus determination framework includes two separate functionalities: 1) determining whether a consensus exists in accordance with one or more specified consensus parameters; and 2) determining a level of consensus in accordance with one or more specified consensus parameters. For example, the consensus determination framework may allow parties to a business transaction (e.g., a receiving party and a supplying party) to come to an agreement concerning one or more of quantities, dates/times, prices, etc. The parties to the transaction may be identified as business partners, supplier and customer, or some other combination. Solely for simplicity herein and not by way of limitation, the two parties for which consensus determination will be described will be referred to as a receiving party and a supplying party.

For both functionality (1) and (2) mentioned above, the consensus determination framework may be embodied in a consensus determination engine that can reside, for example, in an enterprise network system, such as a supply chain management (SCM) system. The system generates a data set representing the expectations of the receiving party and the proposed delivery of the supplying party. In one embodiment, the consensus determination can be performed on historical data for purposes of identifying patterns, generating expectations, etc. The data representing the expectations of the two parties is provided to the consensus determination framework to perform functionality (1) and/or functionality (2). Note that the consensus determinations can be performed individually on different aspects of the input data. As used herein, the different aspects of the input data can refer to any distinguishable element of the data, such as individual days of a forecast series, timing expectations, cost expectations, etc. Thus, for example, data representing expected deliveries for the next five days can be analyzed one day at a time. The data can also, or alternatively, be analyzed with respect to consensus in product quantities, or prices, and so forth. The analyses are performed with respect to consensus parameters, which may refer to parameters used for functionality (1) or functionality (2). The parameters for the analyses are determined on the fly.

Regarding functionality (1), such a consensus determination functionality may be referred to as a “deviation analysis” or a “consensus analysis.” In one embodiment, determining whether consensus exists is performed by comparing expectations between the parties to determine whether the expectations are within specified thresholds. Thus, a deviation analysis functionality or service may evaluate whether or not (a binary result) there is a consensus given the input data and the consensus parameters (more particularly, the thresholds).

As an example, consider a receiving party (a customer) that requests products from a supplying party (a supplier). The requests of the receiving party are compared with the confirmations of the supplying party. The comparison is performed by means of a determination algorithm, which is determined on the fly. Determining the algorithm on the fly allows the consensus determination framework to allow for different algorithms to be applied for different relationships. For example, if the determination analysis is performed by the supplying party, different algorithms can be used with respect to different receiving parties.

In one embodiment, the thresholds or consensus parameters may be provided as profiles that define ranges of acceptability for the transaction. Such ranges may cover aspects of the transaction such as under-delivery tolerances, over-delivery tolerances, time profiles (delayed or premature delivery tolerances), price fluctuation tolerances, etc. In one embodiment, the profiles are hierarchical and can be applied in an order of importance for one of the parties. For example, if price is a more significant aspect than timing for a particular receiving party, the profile of the receiving party may indicate one delay tolerance if the price is within one range, and a different delay tolerance if the price is within a different range. Thus, the logic of the determination algorithms can be sophisticated.

In one embodiment, the on-the-fly determination of profiles (and consequential determination of algorithm) is performed using permissible classes. For example, a class can be determined with a condition technique, which is then used to determine a quantity profile. As used herein, condition technique or condition technique determination refers generally to a technique that allows establishing and setting different scenarios for different conditions. The general sequence of activities for a condition technique may be defined as: A) define condition types for each of the desired data elements of the input data; B) define condition tables to enable the system to store and retrieve condition records for each of the different condition types; C) define access sequences that enable the system to find valid condition records; and, D) group condition types and establish their sequences in system procedures. More particularly as applied herein, activity (A) defines condition types for each element of input data that is of significance for the parties. Such significant elements are the different “aspects” referred to above. Tables may be defined for each separate aspect. Thus, pricing tables, delay tolerance tables, etc., may be generated to provide records for each aspect of the transaction. The underlying system need not be modified to implement changes to a party's profiles—the data simply needs to be updated, and the condition technique will find the updated information.

Regarding functionality (2), such a consensus determination functionality may be referred to as a “consensus finding” or a “consensus determination analysis.” In one embodiment, determining an amount of consensus is performed by performing a function or operation (other than the comparison operation described above) on the input data as defined in a consensus determination rule to identify transaction terms that are acceptable to both parties. As with functionality (1), the consensus rules are determined on the fly or dynamically, which allows the application of different rules to different business parties in different scenarios.

In one embodiment, a rule can be defined as an algorithm or function to manipulate the input data. While the basic principle is the same and both a rule and a profile can be considered consensus parameters, a rule may be defined as an algorithm while a profile may be defined as a threshold/range. As used herein, in one embodiment, “consensus parameter” should be understood to include rules, profiles, and/or other implementations of parameters that may be thought of. An example of a rule could be an averaging function. Other algorithms are possible, and some are identified below.

In one embodiment, the consensus determination framework can be includes components or elements necessary to provide both functionality (1) and (2). Such a framework may include permissible classes, profiles, rules, and access sequences. The consensus determination framework may be applicable to supply network chain (SNC) applications, such as a collaborative sales forecasting and/or order forecasting application. In one embodiment, the consensus framework may be applied to existing data from completed transactions, for example, for determining expectations or evaluating prior transactions.

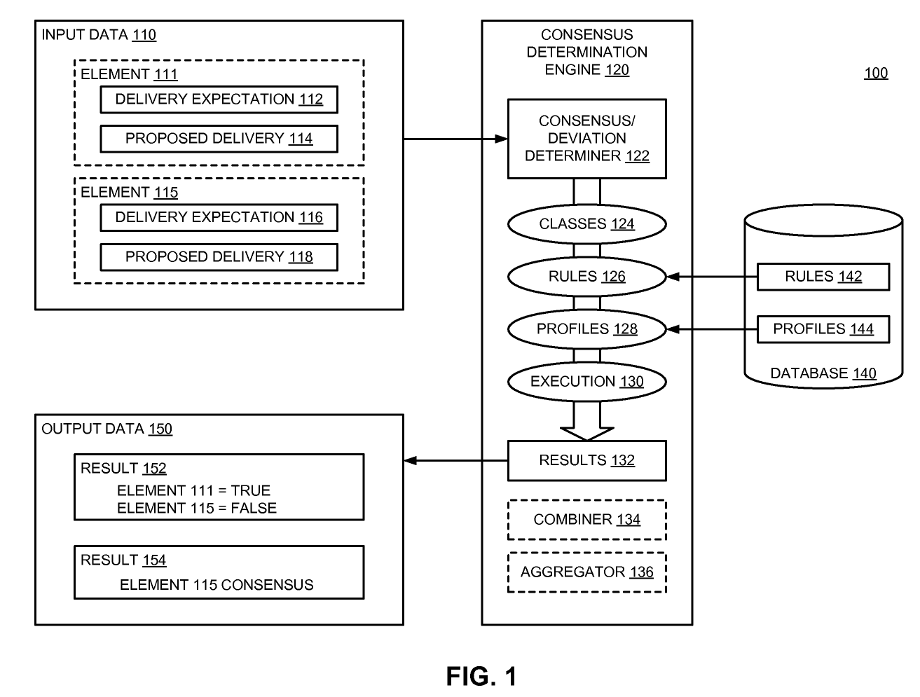

FIG. 1 is a block diagram of an embodiment of a system having a consensus determination engine to determine a consensus of one or more transactions. System 100 represents an enterprise system according to one embodiment, with a consensus determination framework implemented in consensus determination engine 120. Consensus determination engine 120 receives input data 110, which describes one or more elements of a transaction.

Input data 110 includes element 111, which may include delivery expectation 112 and proposed delivery 114. In one embodiment, delivery expectation 112 and/or proposed delivery 114 are time series data, where values are represented in a particular order, and each value is associated with a particular time period (e.g., a day, a week). Delivery expectation 112 may include data identifying a quantity, price, timing for delivery, etc. Similar data elements exist in proposed delivery 114. Input data 110 similarly includes element 115, which includes data related to a transaction. Element 111 and element 115 do not necessarily describe data related to the same transaction, or even for the same transacting parties. Element 115 includes delivery expectation 116 and proposed delivery 118, each including data related to one or more aspects of the transaction.

Consensus determination engine 120 includes consensus/deviation determiner 122. Consensus/deviation determiner 122 represents one or more modules that provide either a consensus determination (how much consensus is there) or a deviation analysis (is there consensus), or both. For example, determiner 122 may include an input data analysis module that receives the data, a parameter identifier to implement the rules and profiles services, and an execution engine to implement an analysis service. In one embodiment, determiner 122 identifies one or more aspects of data from elements 111 and 115 that are used as keys in performing a condition technique determination. Each of classes 124, rules 126, profiles 128, and execution 130 may be referred to as a service, for which determiner 122 may include a separate functional module. Classes 124 represent a class determination made by determiner 122 for an identified key. Rules 126 represent a rule search performed by determiner 122 with the identified aspect of data. The rule resulting from the search will be associated with performing an analysis of the data with respect to that particular aspect of the data. Profiles 128 represent a profile search performed by determiner 122 with the identified aspect of data, for a profile associated with performing an analysis of the data with respect to the identified aspect of data.

Database 140 represents one or more databases in which rules 142 and profiles 144 are stored, and from which they may be subsequently retrieved, on the fly, to perform an analysis. Database 140 may be a storage system associated with an enterprise application that invokes consensus determination engine 120, or may be associated with some other system. In one embodiment, rules 142 and profiles 144 represent tables stored in database 140. Each of rules 142 and profiles 144 may be many groups of records distributed throughout multiple different storage systems.

Execution 130 represents a function of determiner 122, which applies the identified rules and/or profiles to input data 110. Note that some or all of input data 110 may be received at consensus determination engine 120, and rules or profiles may be applied to some or all data that is received. Execution 130 generates results 132, which are consensus determination results. The consensus determination results can indicate whether a consensus exists, and what are the terms of the consensus.

Results 132 are further illustrated by output data 150, which may be formatted and returned to an invoking system. In one embodiment, result 152 represents a deviation analysis result, where element 111 is indicated as TRUE (e.g., the delivery expectation and proposed delivery elements were within a specified threshold range) and element 115 is indicated as FALSE (e.g., the delivery expectation and proposed delivery elements were outside the specified threshold range). In one embodiment, result 154 represents a consensus determination, where element 115 is evaluated for a consensus between delivery expectation 116 and proposed delivery 118. Such a consensus could represent, for example, numbers that are the lower of quantities indicated on the delivery expectation and proposed delivery for a specified delivery period. In one embodiment, thresholds could be applied to a consensus determination (e.g., the consensus determination is an average, as long as the average falls within a certain range). Such thresholds could be applied by applying both rules and profiles, or by having more elaborate rules.

In one embodiment, consensus determination engine 120 optionally includes combiner 134. Combiner 134 is a module that enables consensus determination engine 120 to combine results of multiple input data analyses. Thus, determiner 122 may perform analysis on multiple aspects of input data 110 (e.g., perform analysis on each day of a series) to generate multiple results. Combiner 134 combines the results of a single element of input data.

In one embodiment, consensus determination engine 120 optionally includes aggregator 136. Aggregator 136 is a module that enables consensus determination engine 120 to aggregate results for multiple input data analyses. Aggregator 136 can combine the results of multiple different elements of input data. Thus, determiner 122 can perform analysis on multiple aspects of multiple different input data elements, which aggregator 136 can combine.

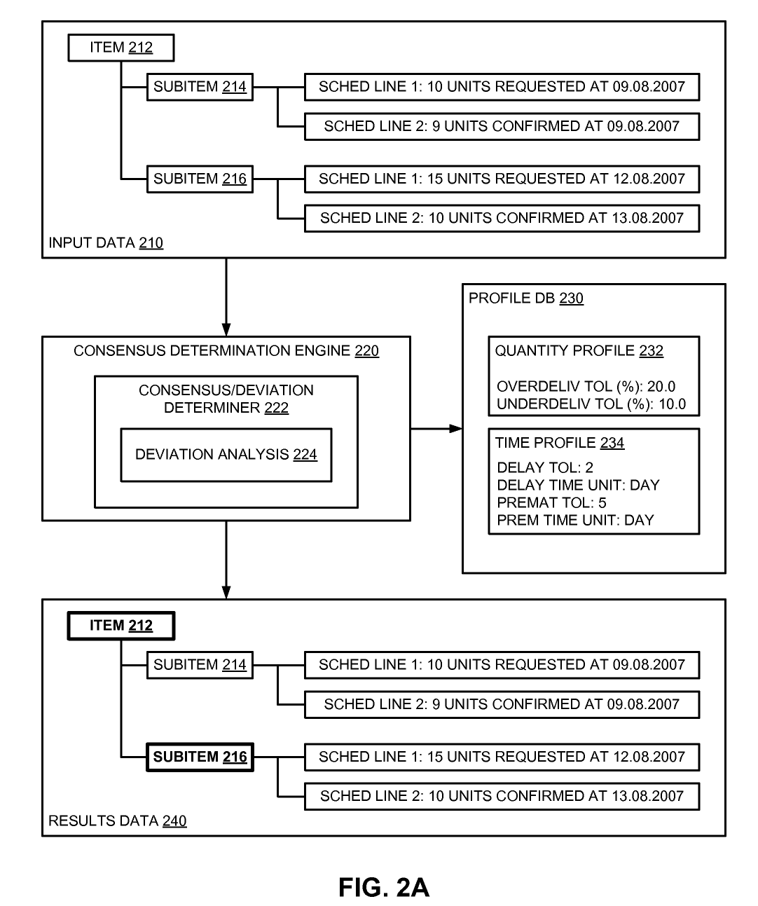

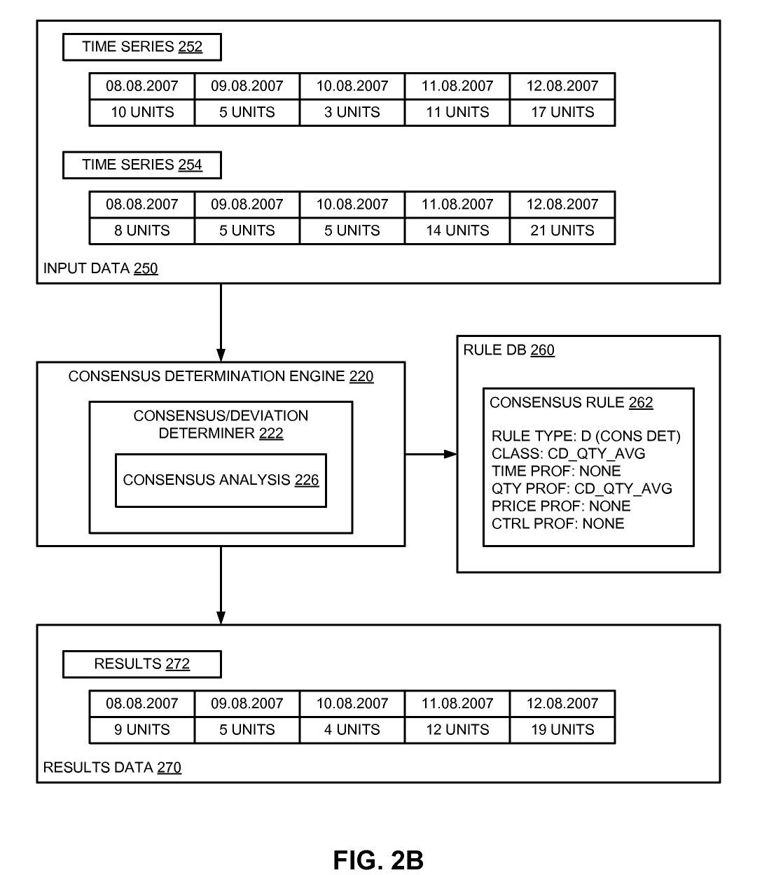

FIG. 2A is a block diagram of an embodiment of a system to identify consensus or deviation in transaction data. Input data 210 includes item 212, which may be an item of a transaction report. For example, item 212 may be a particular product type. Subitems 214 and 216 are further breakdowns of item 212, for example, specific part numbers of the product type. While an example of product type and part number is given, item 212 and subitems 214 and 216 represent any other organization of data that could also be used.

Subitem 214 includes schedule (sched) line 1, which indicates 10 units requested for Aug. 9, 2007. Schedule line 2 indicates 9 units confirmed for Aug. 9, 2007. Thus, there is a one unit discrepancy between the supplying party and the receiving party with respect to subitem 214. Subitem 216 includes schedule line 1, which indicates 15 units requested for Aug. 12, 2007, while schedule line 2 indicates 10 units confirmed for Aug. 12, 2007. Thus, subitem 216 has a 5 unit discrepancy between the supplying party and the receiving party.

Consensus determination engine 220 is an example of an implementation of a consensus determination framework according to any embodiment described herein. Consensus determination engine 220 includes consensus/deviation determiner 222, which may further include deviation analysis module 224. Consensus/deviation determiner 222 may include multiple other modules that are not illustrated in FIG. 2A. Deviation analysis 224 enables consensus determination engine 220 to provide a binary consensus result for input data 210. Deviation analysis 224 applies one or more profiles to input data 210 to perform the analysis.

Profile database (db) 230 represents one or more storage locations within an enterprise where consensus profile data is stored. In one embodiment, profile database 230 includes quantity profile 232 and time profile 234. Quantity profile 232 informs an analysis with respect to a quantity aspect of transaction data. Quantity profile 232 may indicate any type of information about quantity thresholds. For example, quantity profile 232 illustrates overdelivery tolerance as 20%, and underdelivery tolerance as 10%. Thus, any overdelivery of greater than 20% will result in a consensus failure. Likewise, any underdelivery of greater than 10% results in a consensus failure for that aspect of the transaction. Note that failure of an aspect of a transaction may not necessarily mean general failure of the transaction.

Time profile 234 illustrates tolerances related to a timing aspect of the transaction. The profile illustrated specifies a delay tolerance of 2 days, and a premature delivery tolerance of 5 days. Other parameters could be defined. The time profile is provided as illustrative of information that could exist within profile database 230.

Application of quantity profile 232 would result in a consensus for subitem 214, but a failure for subitem 216. That is, the quantity (10−9=1) is less than 2, or 10% of the 10 units requested. Thus, there is consensus as to the quantity for the August 9 delivery. However, the quantity (15−10=5) is greater than 1.5, or 10% of the 15 units requested.

Application of time profile 234 results in a consensus for both subitems 214 and 216. With regard to subitem 214, the confirmed proposed delivery is the same day as the requested delivery (August 9), which is within the 2-day delay specified in time profile 234. Likewise, although schedule line 2 of subitem 216 indicates confirmed proposed delivery a day later than the requested data (August 13 as opposed to August 12), the one day delay is within the 2-day delay parameter defined in time profile 234.

In one embodiment, results data 240 illustrates the same data in the same layout as input data 210, with one or more indicators of consensus failures. For example, as illustrated, subitem 216 is highlighted as failed, and item 212 is highlighted as failed due to the failure of subitem 216. Subitem 214 can be presumed a consensus, because no indication was given of failure on that data.

FIG. 2B is a block diagram of an embodiment of a system to identify an amount of consensus in transaction data. Input data 250 includes time series 252 and time series 254. Assume that time series 252 represents a times series specifying a delivery expectation from a receiving party, and time series 254 represents a time series for a corresponding supplying party to a transaction. The delivery expectations for the receiving party for August 8-August 12, respectively, are 10, 5, 3, 11, and 17 units. The proposed delivery for the supplying party for the same period are, respectively, 8, 5, 5, 14, and 21 units.

Input data 250 is received at consensus determination engine 220, which has consensus/deviation determiner 222. In one embodiment, consensus/deviation determiner 222 includes consensus analysis module 226, which enables consensus determination engine 220 to perform a consensus analysis on input data 250 to determine an extent to which consensus exists or a level of consensus, according to consensus parameters. More particularly, consensus analysis module 226 applies rules obtained from rules database 260. In one embodiment, consensus analysis module 226 extracts the parties as keys, as well as other information related to the context of the transaction, such as identifying quantity consensus. Consensus rule 262 provides a consensus rule for the two parties for consensus determination with respect to quantity.

Consensus rule 262 may include information such as an identifier of the rule type (D for consensus determination), a class of the rule (consensus determination quantity average (CD_QTY_AVG)), and time, quantity, price, and control profiles. The class of the rule is a quantity averaging function, which indicates that a consensus is determined by simply averaging the two values for each aspect of the transaction. Thus, consensus for August 8 becomes (10+8)/2=9, consensus for August 9 becomes (5+5)/2=5, and so forth. Such results are reflected in results 272 of results data 270. Note that for August 11, the consensus determination for an averaging analysis would generate (11+14)/2=12.5. Seeing that a partial unit is likely not shippable, and may not even be possible, consensus determination engine 220 can include internal rules such as rounding down fractions of a unit. Thus, in results 272, August 11 indicates a consensus of 12 units. While a simple case is illustrated, as mentioned above, more complex cases may be devised, where layered or hierarchical rules may be applied.

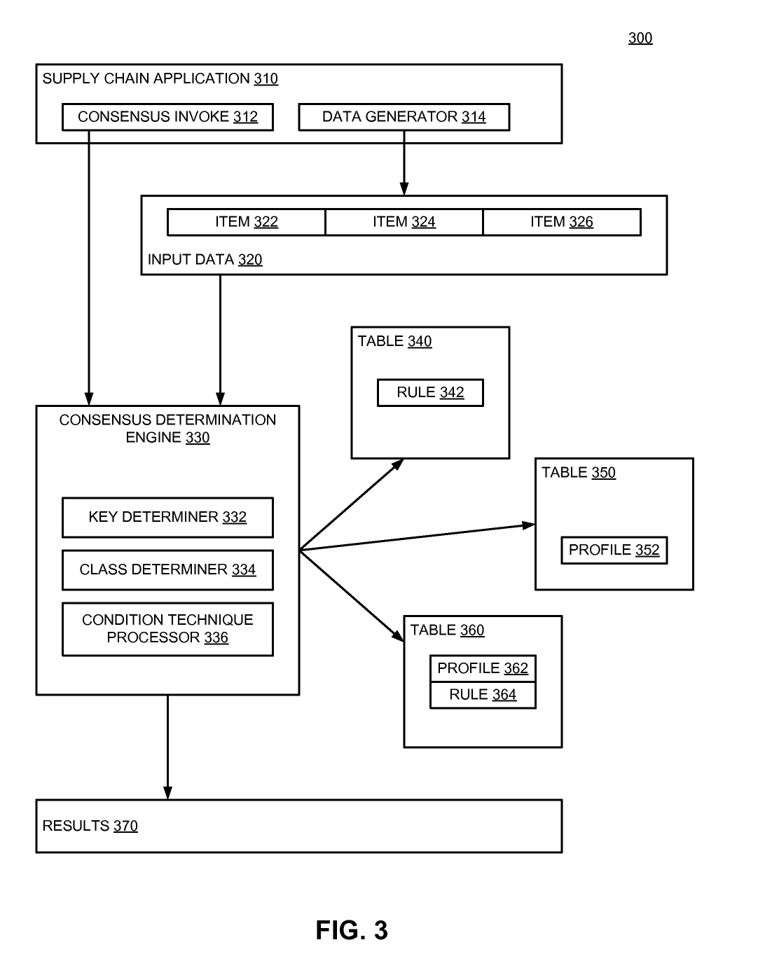

FIG. 3 is a block diagram of an embodiment of a consensus determination with a condition technique processor. System 300 represents a system within an enterprise where a consensus determination framework is established and may be executed. For example, system 300 may be an SNC system. System 300 includes supply chain application 310 that executes within the environment of system 300 to perform operations related to supply network planning, management, or control.

Application 310 includes consensus invoke module 312 and data generator 314. Consensus invoke module 312 represents interfaces, function calls, routines, etc., which enable supply chain application 310 to invoke a consensus determination. Invoking the consensus determination may include instantiating consensus determination engine 330 with input data 320 as input transaction data for the analysis. Data generator 314 may include user interfaces, system interfaces, database interfaces (e.g., SQL (simply query language) interfaces, etc.) to enable supply chain application 310 to retrieve (e.g., obtain from enterprise backend systems) and/or create (e.g., receive user input) transaction data to provide to consensus determination engine 330 for analysis.

Data generator 314 produces input data 320, which may include at least formatting obtained data for analysis. Note that a particular format of the data is not necessarily important. Formatting the data may simply be relating all necessary aspects of the data (e.g., linking dates to quantities, or quantities to prices, for example) for consensus determination engine 330 to evaluate.

In one embodiment, consensus determination engine 330 includes key determiner 332, class determiner 334, and condition technique processor 336. One or more of the illustrated modules may be optional. Key determiner 332 enables consensus determination engine 330 to extract information from input data 320 to identify key data elements that are used to identify corresponding rules/profiles. Input data 320 includes items 322-326, which may each include various aspects such as timing, quantity, etc. One or more of the aspects of the items is a key for a particular consensus analysis. Different aspects of the data will be keys for other analyses.

In one embodiment, a timing deviation analysis is executed by consensus determination engine 330. Timing information is extracted from items 322-326 and keys generated to use to identify timing profiles for the transaction. In one embodiment, a class for the keys is determined by class determiner 334, and then the keys are used to find profile 352 of table 350 and profile 362 of table 360. The finding of the profiles is performed by condition technique processor 336 according to a condition technique determination.

Similarly, in one embodiment, a quantity consensus analysis is executed by consensus determination engine 330. Quantity information is extracted from items 322-326 and keys generated to use to identify quantity rules for a determination for the transaction. In one embodiment, a class for the keys is determined by class determiner 334, and then the keys are used to find rule 342 of table 340 and rule 364 of table 360. The finding of the rules can be performed by condition technique processor 336 according to a condition technique determination.

In one embodiment, tables only include a single type of consensus parameter. That is, perhaps a particular table only includes consensus rules, while other tables include consensus profiles. Alternatively, consensus rules and consensus profiles can be stored together (e.g., table 360), and obtained by consensus determination engine 330 in accordance with a condition technique determination. Results of the consensus determinations with the consensus parameters are generated as results 370, which may be returned to supply chain application 310 for rendering in a user interface (UI) of the application.

In addition to what may be considered software components, system 300 includes hardware on which one or more components may execute, or in which one or more components may be embodied. Although not explicitly shown, hardware components may include memory (e.g., random access memory (RAM), flash) and a processor (e.g., microcontroller, central processing unit (CPU), programmable logic device, etc.). Execution of the functional elements can be considered to be executed on hardware resources of system 300.

Various components described above may be a means for performing the functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc. Software content (e.g., data, instructions, configuration) may be provided via an article of manufacture including a machine readable medium, which provides content that represents instructions that can be executed. The content may result in a machine performing various functions/operations described herein. A machine readable medium includes any mechanism that provides (i.e., stores and/or transmits) information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A machine readable medium may also include a storage or database from which stored content can be downloaded. A machine readable medium may also include a device or product having content stored thereon at a time of sale or delivery. Thus, delivering a device with stored content, or offering stored content for download over a communication medium may be understood as providing an article of manufacture with such content described herein.

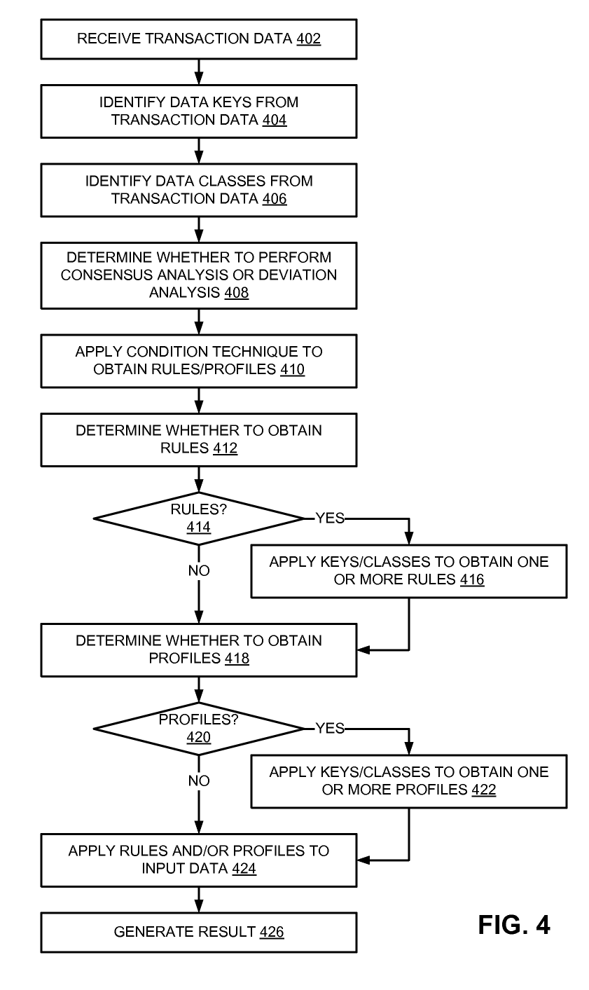

FIG. 4 is a flow diagram of an embodiment of a process for determining a consensus in a transaction. A flow diagram as illustrated herein provides examples of sequences of various process actions. Although shown in a particular sequence or order, unless otherwise specified, the order of the actions can be modified. Thus, the illustrated implementation should be understood only as an example, and the process for establishing the secure channel can be performed in a different order, and some actions may be performed in parallel. Additionally, one or more actions can be omitted in various embodiments of the invention; thus, not all actions are required in every implementation. Other process flows are possible.

A consensus determination framework receives transaction data, 402. In one embodiment, the transaction data is received from an application that invokes the consensus determination framework. That is, an application (e.g., a supply chain application) can include logic within the application itself that causes the application to invoke the consensus framework. For example, an application may invoke the framework every time a proposed delivery is confirmed. As another example, the application may invoke the framework every time a request is received from a receiving party. The triggers for the application to invoke the framework are implementation specific, and thus will vary.

Alternative to the application invoking the framework automatically via the application logic, the consensus determination framework can be invoked via some other mechanism (e.g., manually by a user) and the transaction data retrieved from an indicated storage location. The framework identifies data keys from the transaction data, 404. The identification of the keys depends on the type of consensus analysis will be performed. In either the case of automatic invocation of the framework from within the logic of an enterprise network application, or the case of the framework being invoked via user input, the framework receives an indication of a type of analysis. The type of analysis may be indicated, for example, in a request that invokes the framework or a request for a specific type of analysis.

In one embodiment, the framework identifies data classes from the transaction data, 406. Such identification of classes may be performed in conjunction with identification of the data keys. In certain implementations, there is no distinction between identifying the data keys and identifying the data classes. However, there may be implementations where classes are not used, and another mechanism is employed to identify data keys to use in determining a consensus parameter.

In one embodiment, the framework determines whether to perform a consensus analysis or a deviation analysis, 408. Such a determination may be the logical result of processing a request, or it may require additional processing by the framework. Whether for consensus analysis or deviation analysis, the framework will obtain rules and/or profiles, or collectively, consensus parameters. In one embodiment, the framework applies a condition technique to obtain the rules and/or profiles, 410. The framework may determine whether to obtain rules with the condition technique, 412, and/or determine whether to obtain profiles, 418.

In one embodiment for purposes of simplicity, and not by way of limitation, as described herein rules refer to consensus parameters for a consensus analysis. Profiles refer to consensus parameters for a deviation analysis. Thus, the determination of whether to obtain rules, 412, may be performed in conjunction with determining whether to perform a consensus analysis or a deviation analysis, 408. If rules are to be obtained, 414, the framework applies the keys and/or classes to obtain one or more rules, 416. After the rules are obtained, and/or if no rules are to be obtained, 414, the framework may determine whether to obtain a profile, 418. Note that the ordering of the determinations is arbitrary, and could easily be switched (e.g., determine whether to obtain a profile and then whether to obtain a rule). Also, if a rule is to be obtained (or similarly with a profile), the framework may be configured to obviate the need to determine whether to obtain the other (the other of the profile or rule).

If the framework is to obtain a profile, 420, the framework applies the keys and/or classes to obtain one or more profiles, 422. If no profiles are to be obtained, 420, or after a profile has been obtained, 422, the framework can apply the selected and obtained consensus parameters (profiles and/or rules) to the received input transaction data, 424. The framework generates a result based on the rule/profile used, and the input data, 426. The result can be returned to the invoking entity, stored in a storage system or on a disk, retained in memory, passed to another application, and/or displayed.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A computer-implemented method comprising:
receiving transaction data that describes a delivery expectation for a receiving party of a transaction, and a proposed delivery of a supplying party of the transaction;
dynamically selecting a consensus parameter to evaluate a consensus between the delivery expectation and the proposed delivery for the transaction data;
applying the consensus parameter to the transaction data to determine a consensus between the delivery expectation and the proposed delivery; and
generating a consensus report based on the application of the consensus parameter to the transaction data.

2. The method of claim 1, wherein receiving the transaction data comprises:
identifying a format of the transaction data to determine how to apply the consensus parameter to the transaction data.

3. The method of claim 1, wherein receiving the transaction data comprises:
receiving the transaction data at a consensus analysis module from a supply chain management (SCM) application that calls the consensus analysis module.

4. The method of clam 3, wherein receiving the transaction data from the SCM application comprises:
receiving the transaction data from a call within the logic of the SCM application without requiring user input to trigger the call.

5. The method of claim 1, wherein dynamically selecting the consensus parameter further comprises:
selecting the consensus parameter according to a condition technique determination, with a selected aspect of the transaction data being a key value used to search consensus parameter tables to identify a consensus parameter applicable to determine consensus for the selected aspect of the transaction data.

6. The method of claim 5, wherein selecting the consensus parameter comprises:
determining a class of the consensus parameter.

7. The method of claim 5, wherein selecting the consensus parameter comprises:
selecting a default parameter if a specific consensus parameter is not found within the tables.

8. The method of claim 1, wherein dynamically selecting the consensus parameter comprises:
selecting a consensus profile defining a range of acceptability for the proposed delivery, where consensus exists if the proposed delivery is within the range of acceptability.

9. The method of claim 8, wherein applying the consensus parameter comprises:
applying the consensus profile to determine whether consensus exists for at least one of delivery date, quantity, or price.

10. The method of claim 1, wherein dynamically selecting the consensus parameter comprises:
selecting a consensus rule defining a consensus algorithm to apply to the transaction data to determine an amount of consensus, where the result of application of the consensus algorithm represents the amount of consensus.

11. The method of claim 10, wherein applying the consensus parameter comprises:
applying one of an average function, a minimum function, or a maximum function.

12. The method of claim 1, wherein the consensus parameter is a first consensus parameter and the consensus report is a first consensus report, and further comprising:
dynamically selecting a second consensus parameter to apply to the transaction data;
applying the second consensus parameter to the transaction data to determine a different consensus between the delivery expectation and the proposed delivery; and
generating a second consensus report based on the application of the second consensus parameter to the transaction data.

13. The method of claim 12, wherein applying the second consensus parameter to determine a different consensus comprises:
applying the second consensus parameter to determine a different consensus for the same aspect of the transaction data.

14. The method of claim 12, wherein applying the second consensus parameter to determine a different consensus comprises:
applying the second consensus parameter to determine a different consensus for a different aspect of the transaction data.

15. The method of claim 12, further comprising:
analyzing a result of the first consensus report and a result of the second consensus report; and
generating an aggregated consensus report indicating an aggregate consensus determination for the transaction data based on the analyzed results.

16. An article of manufacture comprising a machine readable medium having content stored thereon to provide instructions to cause a machine to perform operations including:
receiving transaction data that describes a delivery expectation for a receiving party of a transaction, and a proposed delivery of a supplying party of the transaction;
dynamically selecting a consensus parameter to evaluate a consensus between the delivery expectation and the proposed delivery for the transaction data;
applying the consensus parameter to the transaction data to determine a consensus between the delivery expectation and the proposed delivery; and
generating a consensus report based on the application of the consensus parameter to the transaction data.

17. The article of manufacture of claim 16, wherein the content to provide instructions for dynamically selecting the consensus parameter further comprises content to provide instructions for
selecting the consensus parameter according to a condition technique determination, with a selected aspect of the transaction data being a key value used to search consensus parameter table to identify a consensus parameter applicable to determine consensus for the selected aspect of the transaction data.

18. The article of manufacture of claim 16, wherein the content to provide instructions for dynamically selecting the consensus parameter comprises content to provide instructions for
selecting one or both of a consensus profile defining a range of acceptability for the proposed delivery or a consensus rule defining a consensus algorithm to apply to the transaction data to determine an amount of consensus.

19. The article of manufacture of claim 16, wherein the consensus parameter is a first consensus parameter and the consensus report is a first consensus report, the content to further provide instructions for:
dynamically selecting a second consensus parameter to apply to the transaction data;
applying the second consensus parameter to the transaction data to determine a different consensus between the delivery expectation and the proposed delivery; and
generating a second consensus report based on the application of the second consensus parameter to the transaction data.

20. A consensus determination system comprising:
a consensus determiner having
a data analysis module to receive transaction data describing a delivery expectation for a receiving party of a transaction, and a proposed delivery of a supplying party of the transaction;
a rules identifier module to identify a consensus rule for a consensus determination;
a profile identifier module to identify a consensus profile for a deviation analysis; and
an execution module to perform either or both of a consensus determination or a deviation analysis in accordance with an identified rule or profile, respectively; and
a results generator to generate a consensus report based on the operation of the execution module on the transaction data.

21. The consensus determination system of claim 20, further comprising:
a results combiner to combine results of multiple input data analyses on different aspects of the same input data element.

22. The consensus determination system of claim 20, further comprising:
a results aggregator to aggregate results of multiple input data analyses on aspects of different input data elements.
